(19) United States
(12) Patent Application Publication
(10) Pub. No.: US 2023/0417216 A1
(43) Pub. Date: Dec. 28, 2023

(54) Pressure-Differential Engine Apparatus

(71) Applicant: Vitalii Markov, New York, NY (US)

(72) Inventor: Vitalii Markov, New York, NY (US)

(21) Appl. No.: 18/097,241

(22) Filed: Jan. 15, 2023

Related U.S. Application Data
(60) Provisional application No. 63/354,932, filed on Jun. 23, 2022.

(51) Int. Cl. F03B 17/02; F03B 17/04

(52) U.S. Cl. CPC F03B 17/02; F03B 17/04

(57) ABSTRACT

The present disclosure provides a pressure-differential engine apparatus that takes advantage of the pressure gradient that occurs with changes in height due to gravitational pull in a fluid environment to generate energy. The engine achieves this by way of a closed chain of compressible elements that is wrapped around and coupled to a set of two coaxial horizontal wheels and two vertical wheels. A rigid frame structure holds the wheels in place and a coupling assembly links the rotational motion of the two vertical wheels. The compressible elements at the top experience a different pressure to those at the bottom, causing expansion and contraction of the chain at different points along its length, which in turn generates thrust and rotates the wheels.

### CROSS REFERENCE TO RELATED APPLICATIONS

This patent application claims the benefit and priority of U.S. provisional Application No. 63/354,932, filed 23 Jun. 2022.

### FIELD OF INVENTION

The present invention relates generally to generator systems. More specifically, the present invention relates to a pressure-differential engine apparatus capable of producing energy purely from gradients in ambient fluid density and gravitational pull.

### BACKGROUND

Humankind has long sought after sources of clean energy that can be efficiently harvested and which are environment agnostic. One such energy source with great potential is the pressure gradient that occurs in fluids, both liquid and gas, as a result of gravitational pull.

Pressure-differential engines exist in the prior art. For example, WO2014116692A1 describes an engine that utilizes hydrostatic pressure differentials found or created in various liquids, gases or solutions via a two-stroke piston cycle power generating system, wherein the actions of the pistons perform work or replenish working fluid from a lower head to a higher head, and can be utilized to generate power, pump fluids, or perform work, for example. Multiple power generating systems are interconnected to provide continuous and constant power generation through a penstock and turbine system.

Another example of a pressure differential engine in the prior art is found in WO2021145779A1, which describes a device for transforming energy in the form of work of a piston acting against a pressure in a liquid/fluid, into electrical energy, said liquid/fluid forming a surface towards the atmosphere, said device comprising a non-perforated pipe being open at its two ends and being equipped internally with a moving piston, said device being located with one end above the surface of the fluid and with its other end descending into said fluid to form a pressure difference between the pressure exerted on the piston by the fluid at the top of the pipe and the pressure exerted on the piston from the hydrostatic pressure of the fluid at a lower location of the pipe, the location of said piston being shifted by the addition or removal of fluid into and out of the pipe at the top of the fluid, said piston being connected to an electrical generator for generating power equal to the work difference between the work executed by the fluid at the top pressure of the pipe and the work done by the piston against the pressure at the bottom of the pipe.

While the solutions proposed in the prior art are capable of producing net positive energy, neither of the disclosed systems, nor any prior art, discloses a pressure-differential engine which is capable of remaining self-powered once started, and which could act as a source of continuous free clean energy.

It is within this context that the present invention is provided.

### SUMMARY

The present disclosure provides a pressure-differential engine apparatus that takes advantage of the pressure gradient that occurs with changes in height due to gravitational pull in a fluid environment to generate energy. The engine achieves this by way of a closed chain of compressible elements that is wrapped around and coupled to a set of two coaxial horizontal wheels and two vertical wheels. A rigid frame structure holds the wheels in place and a coupling assembly links the rotational motion of the two vertical wheels. The compressible elements at the top experience a different pressure to those at the bottom, causing expansion and contraction of the chain at different points along its length, which in turn generates thrust and rotates the wheels.

According to a first aspect of the present disclosure, there is provided a pressure-differential engine, comprising: a rigid frame structure having a first end and a second end; a first wheel oriented horizontally and rotatably coupled to the frame structure above the first end; a second wheel oriented horizontally and rotatably coupled to the frame structure below the first end, the second wheel being coaxial with the first wheel; a third wheel oriented vertically and rotatably coupled to the frame structure on one side of the second end by a first axle beam extending along its rotational axis; a fourth wheel oriented vertically and rotatably coupled to the frame structure on an opposing side of the second end by a second axle beam extending along its rotational axis;

The engine apparatus further comprises a coupling assembly connecting the first axle beam to the second axle beam such that rotation of the third or fourth wheel in one direction causes opposing rotation of the other wheel; and a closed chain of compressible elements, the chain being wrapped tautly about portions of the circumferences of the first, second, third, and fourth wheels, and the compressible elements being configured to contract in length in response to increases in external pressure and expand in length in response to decreases in external pressure.

In some embodiments, the compressible elements comprise corrugated cylindrical floats of identical diameter and length, and which are compressible only along their length.

In some embodiments, the compressible elements comprise cylindrical pistons of identical diameter and length.

Each piston may comprise a connecting rod with a ball jointed end for coupling to an adjacent piston to its rear.

In some embodiments, each piston holds a compressible fluid in a sealed chamber. The compressible fluid may be selected to be of lower density than the fluid of the environment of the pressure-differential engine. Furthermore, the frame structure may comprise one or more supporting portions configured support the chain from above.

Alternatively, each piston may holds an incompressible fluid in a sealed chamber, the sealed chamber being in fluid connection with chambers of adjacent pistons via an outlet and inlet, the outlet of each piston being connected by a sealed tube to an inlet of a piston to its rear, such that compression of the piston causes the fluid to flow from the sealed chamber to the chamber of the piston to its rear. In such embodiments, the sealed tubes may encompass or be encompassed by the connections between adjacent cylinders. The incompressible fluid may be selected to be of higher density than the fluid of the environment of the pressure-differential engine. In such embodiments, the frame structure may comprise one or more supporting portions configured support the chain from below.

In yet further embodiments, the compressible elements comprise folded portions of a sealed corrugated hose filled with a compressible fluid.

In some embodiments, one or more of the wheels have flanged rims to hold the chain in place about the circumference.

In some embodiments, the third wheel has a first number of teeth about its circumference, each tooth being separated from adjacent teeth by gaps of a first length, and wherein the fourth wheel has a second number of teeth about its circumference, each tooth separated from adjacent teeth by gaps of a second length.

The first number may be greater than the second number and the first length may be less than the second length.

In some embodiments, the coupling assembly comprises a pair of interlocked gears, each coupled to a respective axle beam.

In some embodiments, the first wheel and the second wheel are of equal diameter. The third wheel and the fourth wheel may also be of equal diameter.

In some embodiments, the diameter of the wheels is selected to match the pressure-differential gradient in external fluid in the environment in which the engine is to be located.

In some embodiments, the weight of the wheels and the compressible elements is selected to match the pressure-differential gradient in external fluid in the environment in which the engine is to be located.

In some embodiments, the dimensions of the frame structure are selected to match the pressure-differential gradient in external fluid in the environment in which the engine is to be located.

In some embodiments, the engine is made entirely of recyclable material.

In some embodiments, the first axle beam and the second axle beam are spring mounted to account for any slack in the chain of compressible elements caused by expansion.

### BRIEF DESCRIPTION OF THE DRAWINGS

Various embodiments of the invention are disclosed in the following detailed description and accompanying drawings.

FIG. 1 illustrates an isometric perspective view of a first example configuration of a pressure-differential engine according to the present disclosure that utilizes a chain of corrugated floats.

FIG. 2 illustrates a second isometric perspective view of the first example configuration.

FIG. 3 illustrates an isometric perspective view of a second example configuration of a pressure-differential engine according to the present disclosure that utilizes a chain of sealed pistons filled with a fluid of lower density than the environment of the engine.

FIG. 4 illustrates a second isometric perspective view of the second example configuration.

FIG. 5 illustrates an isometric perspective view of a third example configuration of a pressure-differential engine according to the present disclosure that utilizes a chain of sealed pistons filled with a fluid of higher density than the environment of the engine.

FIG. 6 illustrates a second isometric perspective view of the third example configuration.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a,” “an” and “the” are intended to include the plural forms as well, unless the context clearly indicates otherwise.

Spatially relative terms, such as “under,” “below,” “lower,” “over,” “upper” and the like, may be used herein for ease of description to describe one element or feature's relationship to another when the apparatus is right side up.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

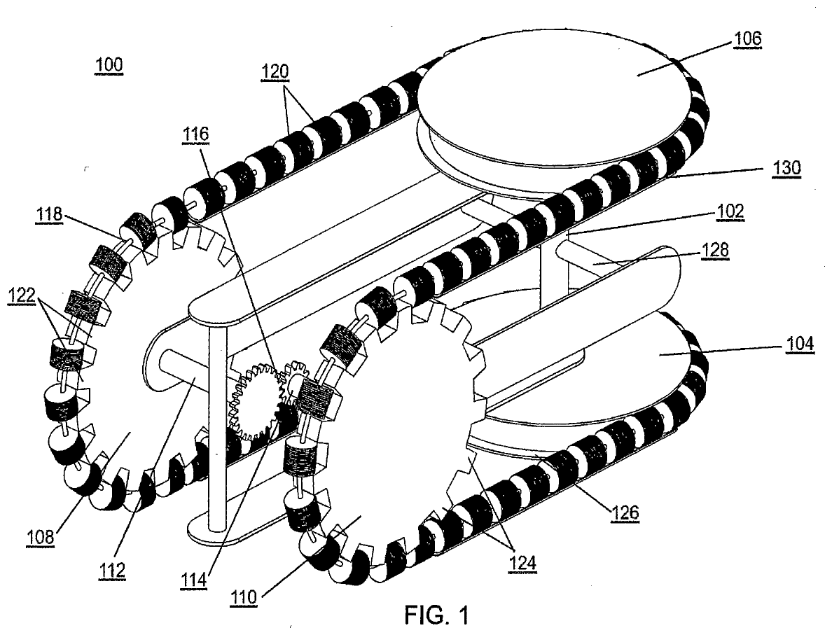

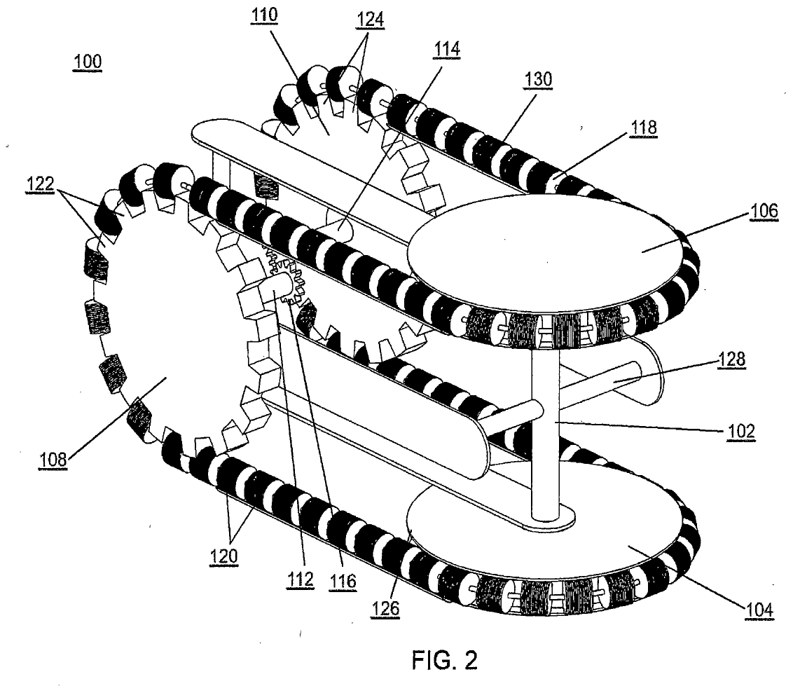

Referring to FIG. 1, an isometric perspective view is shown of a first example configuration of a pressure-differential engine 100 according to the present disclosure. FIG. 2 illustrates a perspective view of the first example from the other side.

As can be seen, the pressure-differential engine 100 comprises a rigid frame structure 102 upon which four wheels are rotatably mounted: a pair of horizontal wheels and a pair of vertical wheels.

The lower horizontal wheel 104 and upper horizontal wheel 106 are mounted above and below one end of the frame 102 respectively such that they are coaxial. The two vertical wheels 108 and 110 are mounted on axle beams 112 and 114 to the second end such that they are oriented parallel to one another and close to coaxial either side of the frame. All the wheels are generally approximately the same diameter to simplify the geometry of construction. Axle beams 112 and 114 are coupled together, in this case by gear assembly 116, such that rotation of a vertical wheel in one direction causes opposing rotation of the other wheel. The rotation of the two horizontal wheels is independent from one another.

The above-described construction is shared across all example configurations of the present disclosure, each of which then also has a closed chain of compressible elements 118 wrapped tautly around the wheels as shown. Some elements could be changed, however—for example an alternative coupling assembly could connect the rotation of the axle beams.

In the present example the compressible elements comprise corrugated floats 120, and the engine 100 is designed to operate in a fluid of high density such as a dense gas or liquid—it could operate underwater for example.

The floats 120 are cylindrical floats of identical diameter and length and which are compressible only along their length. They may comprise reinforcing metal elements about their circumferences to ensure this.

As the surrounding fluid is of greater density at greater depths, i.e. there is greater pressure at the height of the bottom of the two vertical wheels and the lower horizontal wheel 104, the floats 120 will be compressed to a shorter length at that depth which in turn shortens the length of the chain 118, whereas at the upper level, i.e. at the height of the upper horizontal wheel 106 the floats 120 will expand. This change in length, caused by the differential in pressure between the two heights, generates a force that is converted into thrust when the floats 120 reach the bottom and contract.

By constricting the floats 120 from expanding or contracting during transition between the two depths—in this case using the teeth 122 and 124 on the vertical wheels, the change in length is prevented from occurring until the compressible elements leave the circumference of the vertical wheels. The floats 120 arrive at and leave the vertical wheel 110 that takes them downwards in an expanded state, thus the teeth 124 must be fewer and have greater separation between to receive and hold the floats 120. The floats then gradually contract as they are pulled around bottom horizontal wheel 104 until they arrive at the other vertical wheel 108 in a contracted state, which must therefore have a greater number of teeth 122 separated by smaller gaps.

The horizontal wheels have no teeth, but have flanged rims 126 to hold the chain 118 in place about the circumference as it passes around.

The frame 102 is designed to hold the anchor points of the wheels equidistant from a central point, and does so using horizontal arms 128. The frame can also include supports 130 either above or below the compressible elements to prevent them from falling or floating away.

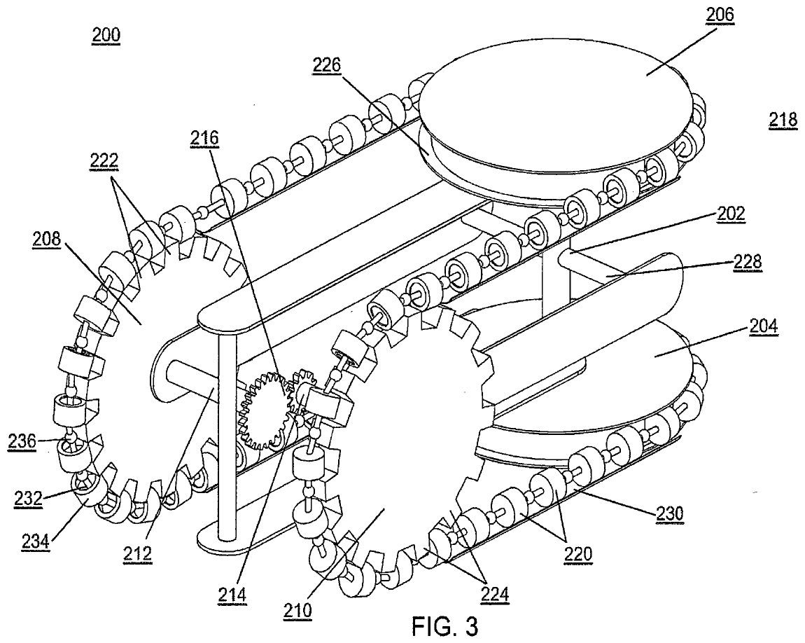

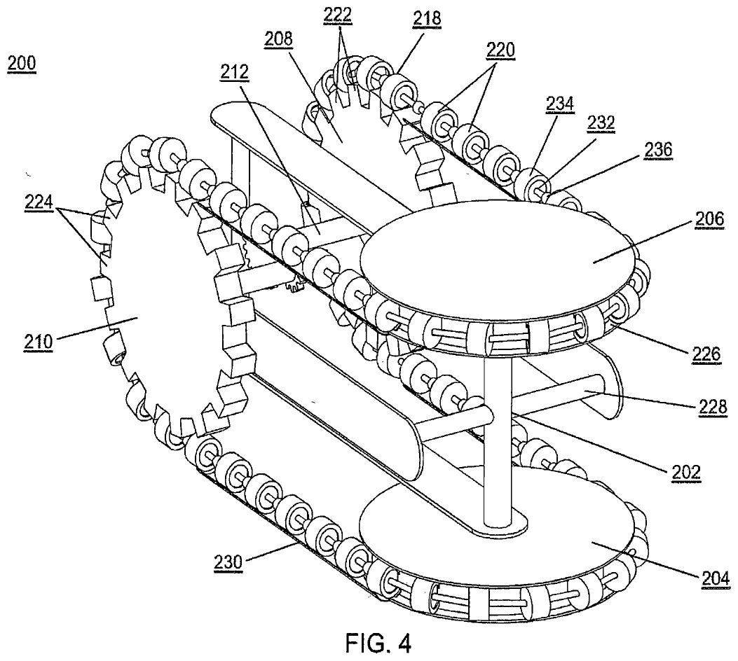

Referring to FIG. 3, an isometric perspective view is shown of a second example configuration of a pressure-differential engine 200 according to the present disclosure. FIG. 4 illustrates a perspective view of the second example from the other side.

This configuration uses sealed pistons as compressible elements instead of corrugated floats, and fills the pistons with a compressible fluid that is of lower density than the surrounding environment—thus it is also suitable for operation in dense gas or liquid environments such as underwater.

As mentioned above, the base construction is the same. The lower horizontal wheel 204 and upper horizontal wheel 206 are mounted above and below one end of the frame 202 respectively such that they are coaxial. The two vertical wheels 208 and 210 are mounted on axle beams 212 and 214 to the second end such that they are oriented parallel to one another and close to coaxial either side of the frame. All the wheels are generally approximately the same diameter to simplify the geometry of construction. Axle beams 212 and 214 are coupled together, in this case by gear assembly 216, such that rotation of a vertical wheel in one direction causes opposing rotation of the other wheel. The rotation of the two horizontal wheels is independent from one another.

The pistons 220 are cylindrical, with identical diameter and length. Each piston 220 in the chain 218 comprises an outer part 234 and an inner part 232 that can move axially within the outer part and that together form a sealed chamber filled with compressible fluid. A connecting rod with a ball jointed end extends from the rear of each piston 220 and coupled to a rod extending from the front of the adjacent piston. Other types of connections could also be used—but they not be flexible or compressible so that the only changes in length of chain 218 are caused by the inner parts 232 of the pistons 220 moving with respect to the outer parts 234 during compression or expansion.

The working principles of this second example are the same as for the first.

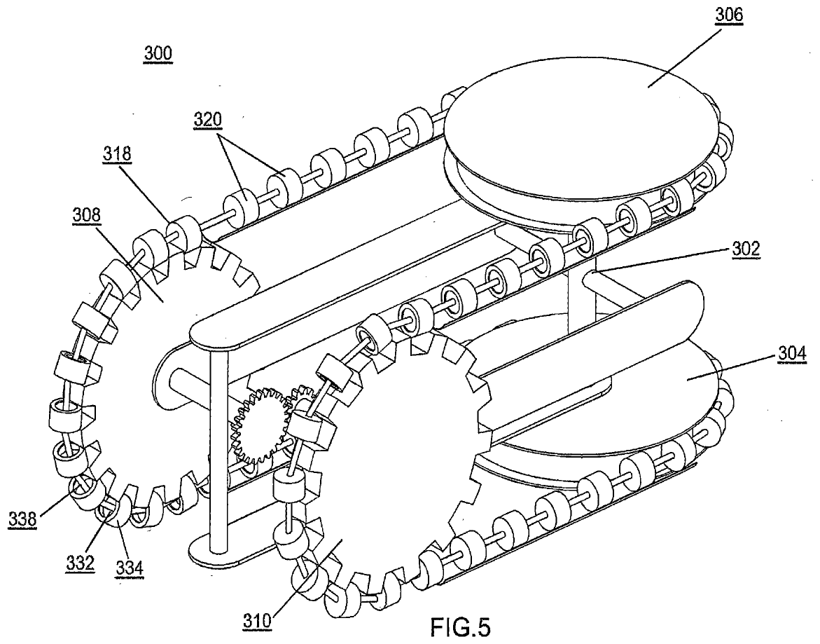

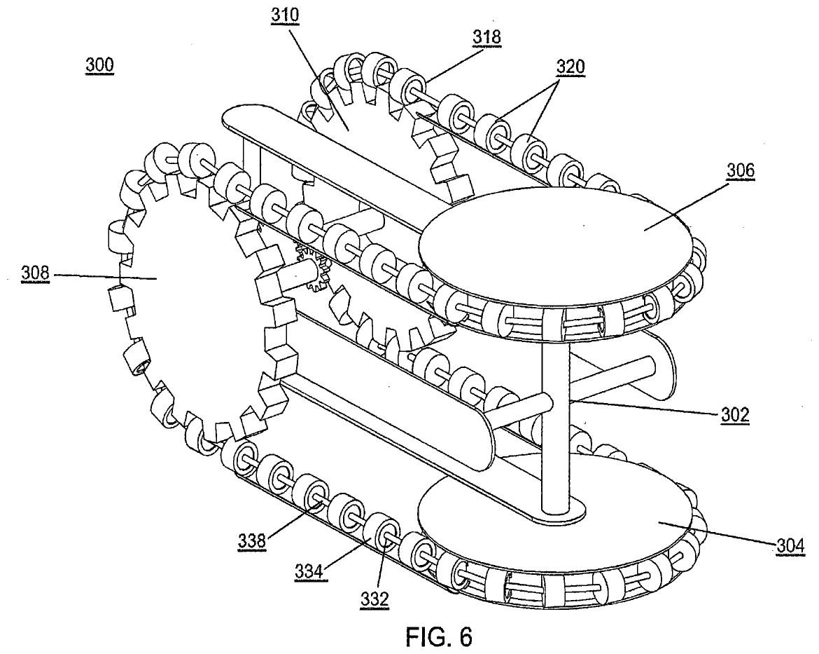

Referring to FIG. 5, an isometric perspective view is shown of a third example configuration of a pressure-differential engine 300 according to the present disclosure. FIG. 6 illustrates a perspective view of the third example from the other side.

This configuration also uses pistons 320 as the compressible elements, but fills them with an incompressible fluid, i.e. a liquid, which is usually of greater density than the surrounding environment of the engine, and the whole chain 318 is fluidically connected.

In this configuration, instead of the fluid being compressed as the inner part 332 is drawn into the outer part 334 of each piston, the fluid is instead pushed through an outlet of the sealed chamber during compression, and into tube 338 which leads to an inlet for the sealed chamber of an adjacent piston to its rear.

The fluid is thus continuously pushed rearwards in the chain 318 from the point where the pistons descend to the lower height on vertical wheel 310. Then as the compressed pistons 320 that have little fluid left inside them exit the other vertical wheel 308 at the upper level and begin expanding, the liquid is drawn into them from the ones in front. The pistons 320 thus gradually fill with fluid and expand as they are drawn around upper horizontal wheel 306 until they are ‘full’ again as they re-enter wheel 308. This means that pistons entering wheel 310 are always heavier than those entering wheel 308, which keeps is the source of thrust in this configuration.

This version of the engine 300 can thus work in environments of extremely light fluid, including the air of earth.

Although not shown, another example configuration of the present disclosure utilizes the same base structure but with the chain of compressible elements being a sealed corrugated hose, with the corrugations being compressed and then expanding as it travels about the wheels.

The diameter and weight of the wheels, as well as the dimensions of the frame structure and the arrangement and ratio of the gears may all be selected to match an expected pressure-differential gradient in external fluid in the environment in which the engine is to be located.

The engine may be made entirely of recyclable material.

In some examples, the first axle beam and the second axle beam are spring mounted to account for any slack in the chain of compressible elements caused by expansion.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and method have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A pressure-differential engine, comprising:
a rigid frame structure having a first end and a second end;
a first wheel oriented horizontally and rotatably coupled to the frame structure above the first end;
a second wheel oriented horizontally and rotatably coupled to the frame structure below the first end, the second wheel being coaxial with the first wheel;
a third wheel oriented vertically and rotatably coupled to the frame structure on one side of the second end by a first axle beam extending along its rotational axis;
a fourth wheel oriented vertically and rotatably coupled to the frame structure on an opposing side of the second end by a second axle beam extending along its rotational axis;
a coupling assembly connecting the first axle beam to the second axle beam such that rotation of the third or fourth wheel in one direction causes opposing rotation of the other wheel; and
a closed chain of compressible elements, the chain being wrapped tautly about portions of the circumferences of the first, second, third, and fourth wheels, and the compressible elements being configured to contract in length in response to increases in external pressure and expand in length in response to decreases in external pressure.

2. A pressure-differential engine according to claim 1, wherein the compressible elements comprise corrugated cylindrical floats of identical diameter and length, and which are compressible only along their length.

3. A pressure-differential engine according to claim 1, wherein the compressible elements comprise cylindrical pistons of identical diameter and length.

4. A pressure-differential engine according to claim 3, wherein each piston comprises a connecting rod with a ball jointed end for coupling to an adjacent piston to its rear.

5. A pressure-differential engine according to claim 3, wherein each piston holds a compressible fluid in a sealed chamber.

6. A pressure-differential engine according to claim 5, wherein the compressible fluid is selected to be of lower density than the fluid of the environment of the pressure-differential engine.

7. A pressure-differential engine according to claim 6, wherein the frame structure comprises one or more supporting portions configured support the chain from above.

8. A pressure-differential engine according to claim 3, wherein each piston holds an incompressible fluid in a sealed chamber, the sealed chamber being in fluid connection with chambers of adjacent pistons via an outlet and inlet, the outlet of each piston being connected by a sealed tube to an inlet of a piston to its rear, such that compression of the piston causes the fluid to flow from the sealed chamber to the chamber of the piston to its rear.

9. A pressure-differential engine according to claim 8, wherein the sealed tubes encompass or are encompassed by the connections between adjacent cylinders.

10. A pressure-differential engine according to claim 8, wherein the incompressible fluid is selected to be of higher density than the fluid of the environment of the pressure-differential engine.

11. A pressure-differential engine according to claim 10, wherein the frame structure comprises one or more supporting portions configured support the chain from below.

12. A pressure-differential engine according to claim 3, wherein the compressible elements comprise folded portions of a sealed corrugated hose filled with a compressible fluid.

13. A pressure-differential engine according to claim 1, wherein one or more of the wheels have flanged rims to hold the chain in place about the circumference.

14. A pressure-differential engine according to claim 1, wherein the third wheel has a first number of teeth about its circumference, each tooth being separated from adjacent teeth by gaps of a first length, and wherein the fourth wheel has a second number of teeth about its circumference, each tooth separated from adjacent teeth by gaps of a second length.

15. A pressure-differential engine according to claim 12, wherein the first number is greater than the second number and the first length is less than the second length.

16. A pressure-differential engine according to claim 1, wherein the coupling assembly comprises a pair of interlocked gears, each coupled to a respective axle beam.

17. A pressure-differential engine according to claim 1, wherein the first wheel and the second wheel are of equal diameter.

18. A pressure-differential engine according to claim 1, wherein the third wheel and the fourth wheel are of equal diameter.

19. A pressure-differential engine according to claim 1, wherein the diameter of the wheels is selected to match the pressure-differential gradient in external fluid in the environment in which the engine is to be located.

20. A pressure-differential engine according to claim 1, wherein the weight of the wheels and the compressible elements is selected to match the pressure-differential gradient in external fluid in the environment in which the engine is to be located.

21. A pressure-differential engine according to claim 1, wherein the dimensions of the frame structure are selected to match the pressure-differential gradient in external fluid in the environment in which the engine is to be located.

22. A pressure-differential engine according to claim 1, wherein the engine is made entirely of recyclable material.

23. A pressure-differential engine according to claim 1, wherein the first axle beam and the second axle beam are spring mounted to account for any slack in the chain of compressible elements caused by expansion.
